(19) United States
(12) Patent Application Publication
(10) Pub. No.: US 2003/0145313 A1
(43) Pub. Date: Jul. 31, 2003

(54) Enhanced instruction scheduling after register allocation by employing traces

(75) Inventor: Spiros Kalogeropulos, Los Gatos, CA (US)

Correspondence Address: Serge J. Hodgson, Gunnison, McKay & Hodgson, L.L.P., Suite 220, 1900 Garden Road, Monterey, CA, 93940, US

(73) Assignee: Sun Microsystems, Inc.

(21) Appl. No.: 10/066,061

(22) Filed: Jan. 30, 2002

(51) Int. Cl. G06F 9/45; G06F 9/44

(52) U.S. Cl. 717/156; 717/132

(57) ABSTRACT

A trace scheduler schedules instructions within a trace and after register allocation. The trace scheduler computes critical path information across the trace, which is used to schedule instructions across basic block boundaries. In this manner, the efficiency of the compiler is maximized.

### BACKGROUND OF THE INVENTION

1. Field of the Invention

The present invention relates generally to compilers. More particularly, the present invention relates to an instruction scheduler for a compiler.

2. Description of the Related Art

Processors rely on the compiler to produce an instruction schedule which extracts and exploits the available instruction level parallelism in a routine to maximize the instruction issue rate and the parallelism of memory operations by issuing prefetches and loads as early as possible.

The process of detecting and scheduling the available instruction level parallelism is usually applied on the control flow graph of a routine, where nodes on the graph are called basic blocks. A basic block is a sequence of consecutive instructions with a single entry and a single exit.

An instruction scheduler uses single basic blocks for detecting and scheduling the available instruction level parallelism. Typically, an instruction scheduler schedules the instructions within the basic blocks before register allocation. During register allocation, additional code is generated, e.g., spill code. Thus, after register allocation, the instruction scheduler again schedules the instructions within the basic blocks including the additional code generating during the register allocation. However, there is often insufficient instruction level parallelism for the instruction scheduler to exploit, which reduces performance of the compiler.

### SUMMARY OF THE INVENTION

In accordance with one embodiment of the present invention, a trace scheduler schedules instructions within a trace and after register allocation. The trace scheduler computes critical path information across the trace, which is used to schedule instructions across basic block boundaries. In this manner, the efficiency of the compiler is maximized.

In accordance with one particular embodiment, a method includes:

allocating registers;

building a trace including basic blocks; and

scheduling instructions within the trace after the registers are allocated.

In another embodiment, the instructions are scheduled within the trace recognizing data dependencies from off trace basic blocks.

In accordance with yet another embodiment, the height information of the instructions is computed. The height information is computed using execution probabilities of the basic blocks. The instructions are scheduled within the trace using this height information.

The present invention is best understood by reference to the following detailed description when read in conjunction with the accompanying drawings.

### BRIEF DESCRIPTION OF THE DRAWINGS

FIG. 1 is a control flow graph including a trace in accordance with one embodiment of the present invention.

FIG. 2 is a flow chart including a trace scheduler in accordance with one embodiment of the present invention.

FIG. 3 is a trace block in accordance with one embodiment of the present invention.

FIGS. 4A and 4B are a flow chart of a build trace block operation of the flow chart of FIG. 2 in accordance with one embodiment of the present invention.

FIG. 5 is a diagram illustrating the updating of a join instruction with a set of registers in accordance with one embodiment of the present invention.

FIG. 6 is the trace block of FIG. 3 after scheduling of instructions to maximize efficiency in accordance with one embodiment of the present invention.

FIG. 7 is a flow chart of a schedule instructions within trace block operation of the flow chart of FIG. 2 in accordance with one embodiment of the present invention.

FIG. 8 is a flow chart of a generate compensation code operation of the flow chart of FIG. 2 in accordance with one embodiment of the present invention.

FIG. 9 is a control flow graph after scheduling of instructions in accordance with one embodiment of the present invention.

FIG. 10 is a flow chart of a restore basic blocks in trace operation of the flow chart of FIG. 2 in accordance with one embodiment of the present invention.

FIG. 11 is a flow chart of an add compensation code operation of the flow chart of FIG. 8 in accordance with one embodiment of the present invention.

FIG. 12 is a block diagram illustrating a computer system upon which an embodiment in accordance with the present invention may be implemented.

Common reference numerals are used throughout the drawings and detailed description to indicate like elements.

### DETAILED DESCRIPTION

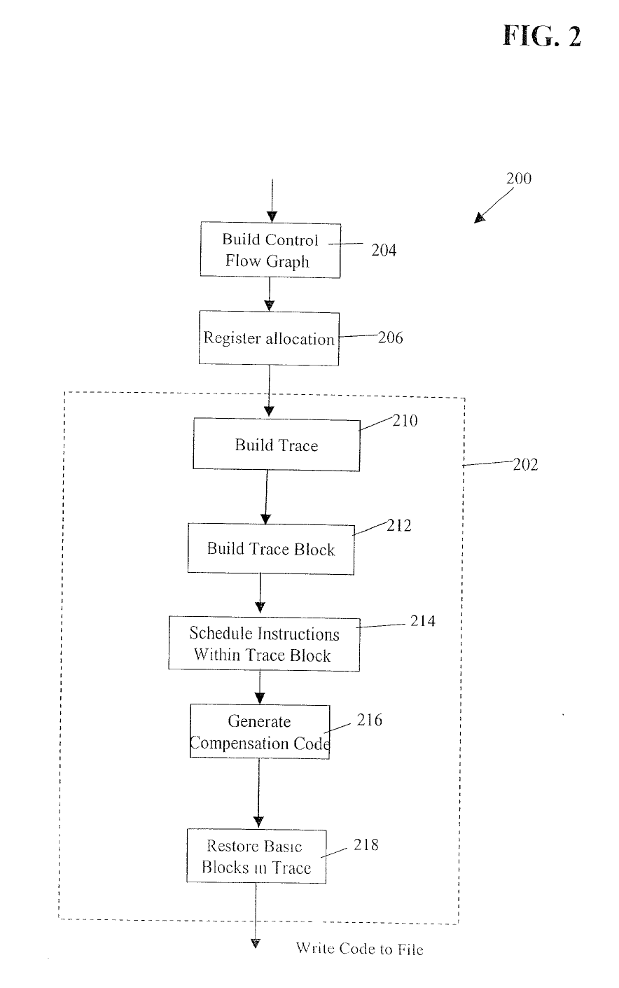

In accordance with one embodiment of the present invention, a trace scheduler 202 (FIG. 2) schedules instructions within a trace and after register allocation, i.e., after register allocation operation 206. Trace scheduler 202 computes critical path information across the trace, which is used to schedule instructions across basic block boundaries. In this manner, the efficiency of the compiler is maximized.

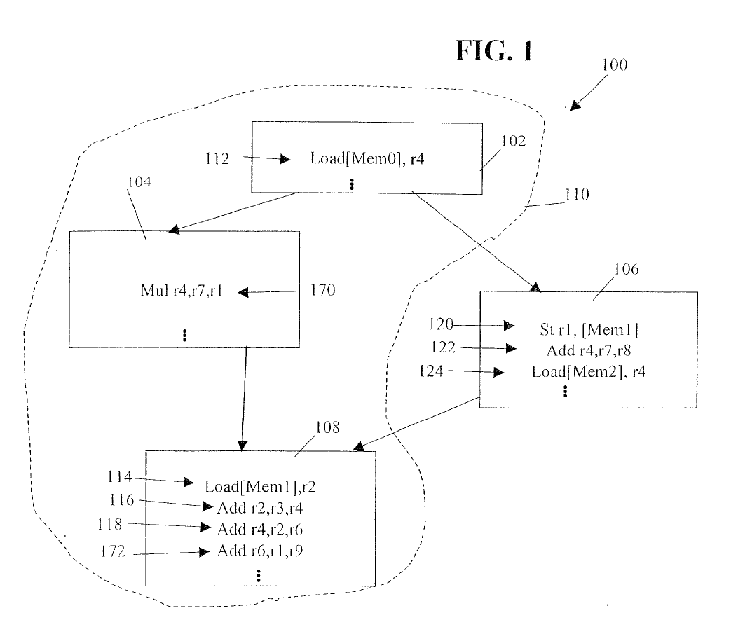

More particularly, FIG. 1 is a control flow graph 100 including a trace 110 in accordance with one embodiment of the present invention. FIG. 2 is a flow chart 200 including a trace scheduler 202 in accordance with one embodiment of the present invention. In one embodiment, trace scheduler 202 schedules instructions using an instruction scheduler, which schedules instructions within basic blocks.

Referring now to FIGS. 1 and 2 together, in build control flow graph operation 204, control flow graph 100 is built. Control flow graph 100 is a graph of the flow through the basic blocks, i.e., basic blocks 102, 104, 106, and 108. Control flow graph 100 is built using any one of a number of techniques well known to those of skill in the art, and the particular technique used to build control flow graph 100 is not essential to the present invention.

Control flow graph 100 includes basic blocks 102, 104, 106, and 108. As indicated by the arrows, the control flow of control flow graph 100 is from basic block 102 to basic block 108 through either basic block 104 or basic block 106.

From build control flow graph operation 204, registers are allocated in register allocation operation 206. In one embodiment, spill code is generated during register allocation operation 206. Registers are allocated and spill code is generated using any one of a number of techniques well known to those of skill in the art, and the particular technique used in register allocation operation 206 is not essential to the present invention.

Further, in one embodiment, after build control flow graph operation 204 and before register allocation operation 206, an instruction scheduler and, optionally, a trace scheduler are invoked to schedule instructions within control flow graph 100.

After register allocation operation 206, basic block 102 includes an instruction 112, which loads the value from memory location Mem0 into register r4. Basic block 104 includes an instruction 170, which multiplies the values in registers r4 and r7 and assigns the result to register r1.

Basic block 106 includes instructions 120, 122 and 124. Instruction 120 stores the value in register r1 in memory location Mem1. Instruction 122 adds the values in registers r4 and r7 and assigns the result to register r8. Instruction 124 loads the value from memory location Mem2 into register r4.

Basic block 108 includes instructions 114, 116, 118 and 172. Instruction 114 loads the value from memory location Mem1 into register r2. Instruction 116 adds the values in registers r2 and r3 and assigns the result to register r4. Instruction 118 adds the values in registers r4 and r2 and assigns the result to register r6. Instruction 172 adds the values in registers r6 and r1 and assigns the result to register r9.

Basic blocks 102, 104, 106 and 108 can include instructions other than those discussed above. These other instructions are not illustrated to avoid detracting from the principals of the present invention.

After register allocation operation 206, process flow enters trace scheduler 202 and, more particularly, moves to build trace operation 210.

In build trace operation 210, trace 110 is built. In one embodiment, trace 110 is built by linking a collection of basic blocks, i.e., basic blocks 102, 104 and 108, which have an execution frequency above a predetermined execution frequency. However, trace 110 is built using a different technique in a different embodiment.

Trace 110 consists of basic blocks 102, 104 and 108. Trace 110 does not include basic block 106 and so basic block 106 is referred to as an off trace basic block 106.

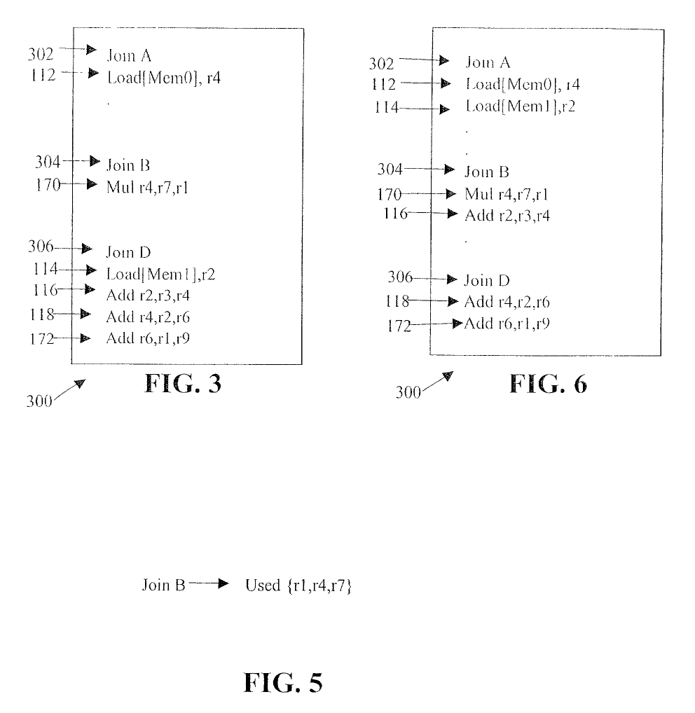

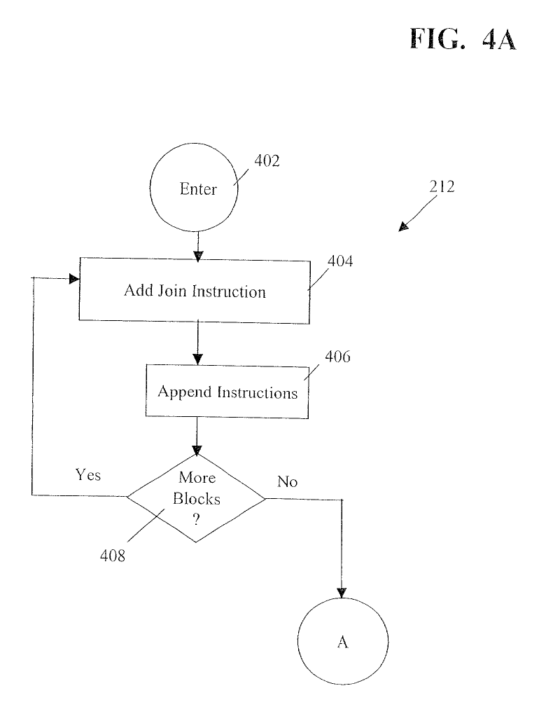

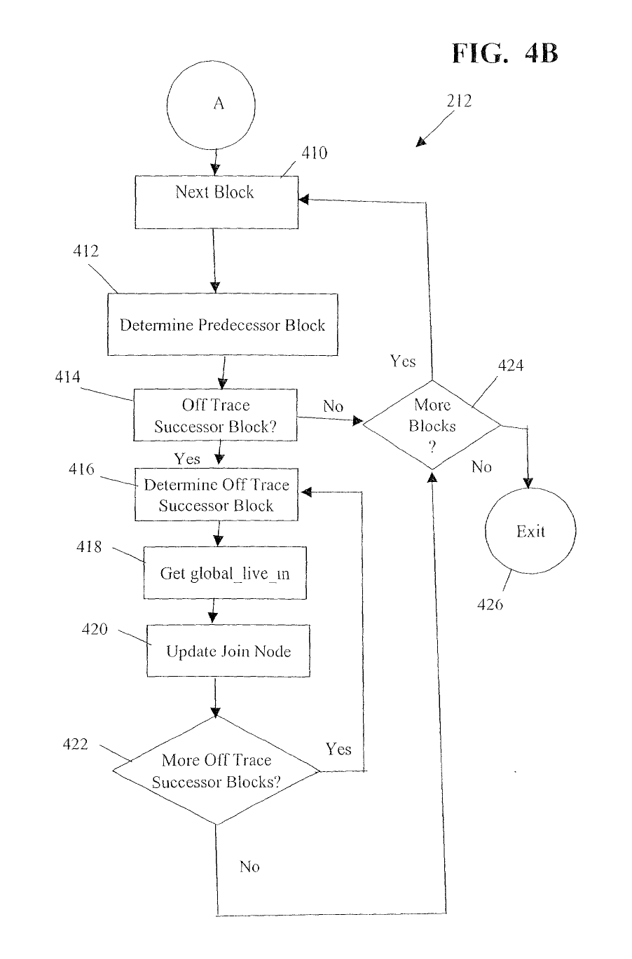

FIG. 3 is a trace block 300 in accordance with one embodiment of the present invention. FIGS. 4A and 4B are a flow chart of a build trace block operation 212 of flow chart 200 of FIG. 2 in accordance with one embodiment of the present invention. Referring now to FIGS. 1, 2, 3 and 4A together, after trace 110 is built in build trace operation 210, process flow moves to build trace block operation 212. In build trace block operation 212, trace block 300 of FIG. 3 is built.

More particularly, from build trace operation 210, build trace block operation 212 is entered from an enter operation 402 (FIG. 4A). For the first basic block of trace 110, i.e., basic block 102, instruction 302 is inserted into trace block 300 in an add join instruction operation 404. Instruction 302 is sometimes called a first join instruction, or a join A instruction, and is hereinafter referred to as join instruction 302.

From add join instruction operation 404, in an append instructions operation 406, the instructions of the first basic block of trace 110, i.e., basic block 102, are inserted into trace block 300 following join instruction 302 and are mapped to join instruction 302. Accordingly, instruction 112 and any other instructions of basic block 102 are inserted into trace block 300 following join instruction 302 and mapped to join instruction 302.

From append instructions operation 406, a determination is made whether or not there are more basic blocks in more blocks operation 408. If a determination is made that there are no more basic blocks in more blocks operation 408, the process moves to next block operation 410 of FIG. 4B. However, if a determination is made that there are more basic blocks in more blocks operation 408, the process returns to add join instruction 404.

In this embodiment, a determination is made that there are more basic blocks in more blocks operation 408, e.g., that there is still basic block 104. Thus, for the following, e.g., second, basic block of trace 110, i.e., basic block 104, instruction 304 is inserted into trace block 300 following the instructions of basic block 102 in add join instruction operation 404. Instruction 304 is sometimes called a second join instruction, or a join B instruction, and is hereinafter referred to as join instruction 304.

From add join instruction operation 404, in append instructions operation 406, the instructions of the second basic block of trace 110, i.e., basic block 104, are inserted into trace block 300 following join instruction 304 and are mapped to join instruction 304. Accordingly, instruction 170 and any other instructions of basic block 104 are inserted into trace block 300 following join instruction 304 and mapped to join instruction 304.

From append instructions operation 406, a determination is made whether or not there are more basic blocks in more blocks operation 408. Operations 404, 406, and 408 are repeated until there are no more basic blocks and the process moves to next block operation 410 of FIG. 4B.

However, in this embodiment, a determination is made that there are more basic blocks in more blocks operation 408, i.e., that there is still basic block 108. Thus, the process returns to add join instruction 404. For the following, e.g., third or last, basic block of trace 110, i.e., basic block 108, instruction 306 is inserted into trace block 300 following the instructions of basic block 104 in add join instruction operation 404. Instruction 306 is sometimes called a third or last join instruction, or a join D instruction, and is hereinafter referred to as join instruction 306.

From add join instruction operation 404, in append instructions operation 406, the instructions of the last basic block of trace 110, i.e., basic block 108, are inserted into trace block 300 following join instruction 306 and mapped to join instruction 306. Accordingly, instructions 114, 116, 118, 172 and any other instructions of basic block 108 are inserted into trace block 300 following join instruction 306 and mapped to join instruction 306.

From append instructions operation 406, a determination is made that there are no more basic blocks in more blocks operation 408. The process moves to next block operation 410 of FIG. 4B.

In the above manner, the instructions of each basic block are mapped to a specific join instruction. Further, each join instruction contains information about which instructions are contained in the particular basic block associated with the join instruction. In addition, each join instruction is a delimiter for the particular basic block associated with the join instruction, i.e., marks where the instructions of the particular basic block associated with the join instructions begin in trace block 300.

To illustrate, instruction 112 is mapped to join instruction 302, which is associated with basic block 102. Instruction 170 is mapped to join instruction 304, which is associated with basic block 104. Similarly, instructions 114, 116, 118 and 172 are mapped to join instruction 306, which is associated with basic block 108.

Further, join instruction 302 contains information that instruction 112 is contained in basic block 102. Join instruction 304 contains information that instruction 170 is contained in basic block 104. Similarly, join instruction 306 contains information that instructions 114, 116, 118 and 172 are contained in basic block 108.

As set forth above, trace block 300 includes all of the instructions of trace 110, i.e., all of the instructions of basic blocks 102, 104, 108. Trace block 300 further includes join instructions 302, 304 and 306.

Upon determining that there are no more blocks in more blocks operation 408, the head block of the trace becomes the target block. In this example, basic block 102 is the head block of trace 110. Accordingly, basic block 102 becomes the target block.

In next block operation 410 (FIG. 4B), the next block in the trace following the present target block becomes the new target block. As set forth above, basic block 102 is the present target block. Accordingly, in next block operation 410, basic block 104 becomes the new target block.

From next block operation 410, in a determined predecessor block operation 412, the predecessor block of the present target block is determined. In this example, basic block 104 is the present target block. The predecessor block, i.e., the immediately preceding basic block, is basic block 102. Accordingly, in determine predecessor block operation 412, a determination is made that basic block 102 is the predecessor block of the present target block, i.e., basic block 104.

From determine predecessor block operation 412, in an off trace successor block operation 414, a determination is made as to whether there are any off trace successor block of the predecessor block determined in determine predecessor block operation 412. An off trace successor block is a basic block, which is not within the trace, and which follows the predecessor block.

If a determination is made that there are no off trace successor blocks of the predecessor block, then process moves to more blocks operation 424. However, if there is an off trace successor block of the predecessor block, then process flow moves to determine off trace successor block operation 416.

In this example, off trace block 106 is not within trace 110, and follows basic block 102, i.e., follows the predecessor block. Accordingly, a determination is made in off trace successor block operation 414 that there is an off trace successor block of the predecessor block and process flow moves to determine off trace successor block operation 416.

In determine off trace successor block operation 416, a determination is made as to which basic block is the off trace successor block. In this example, a determination is made that off trace basic block 106 is the off trace successor block.

From determine off trace successor block operation 416, in a get global_live_in operation 418, the global_live_in for the off trace successor block is obtained. The global_live_in for the off trace successor block is the set of registers which are live, i.e., which contain a live value, when entering the off trace successor block.

Generally, a register is live between the time that the value in the register is defined and the time that the value in the register is used. More particularly, a register is live entering the off trace successor block when the value in the register is used in the off trace successor block (or in off trace blocks which are successors of the off trace successor block) before the value in the register is defined. Stated another way, a register is live when the value in the register is defined before the off trace successor block and used in the off trace successor block (or in off trace blocks which are successors of the off trace successor block) before the value in the register is again defined.

In this example, off trace basic block 106 is the off trace successor block. As discussed above, off trace basic block 106 includes instructions 120, 122 and 124. Instruction 120 stores the value in register r1 in memory location Mem1. Accordingly, the value in register r1 is used before it is defined and the global_live_in includes register r1. Instruction 122 adds the values in registers r4 and r7 and assigns the result to register r8. Accordingly, the values in registers r4 and r7 are used before they are defined and the global_live_in includes registers r4 and r7. Accordingly, the global_live_in for off trace basic block 106 is the set of registers r1, r4 and r7.

From get global_live_in operation 418, in an update join instruction operation 420, the use set of the join instruction of the present target block is updated with the global_live_in obtained in get global_live_in operation 418. Stated another way, the global_live in is mapped to the join instruction of the present target block.

A use set of an instruction is a set of registers used by the instruction. The use set is used to determine data dependencies between instructions as those of skill in the art will understand.

In this example, the use set of join instruction 304 is updated with the global_live_in for off trace basic block 106. More particularly, the use set of join instruction 304 is updated with the set of registers r1, r4 and r7 as illustrated in FIG. 5.

From update join node operation 420, in more off trace successor blocks operation 422, a determination is made as to whether there are more off trace successor blocks. If a determination is made that there are more off trace successor blocks, operations 416, 418, 420 and 422 are repeated for all of the off trace successor blocks.

If a determination is made that there are no more off trace successor blocks in more off trace successor blocks operation 422, then process flow moves to more blocks operation 424.

In this example, off trace basic block 106 is the only off trace successor block of the predecessor block, i.e., of basic block 102. Accordingly, in more off trace successor blocks operation 422, a determination is made that there are no more off trace successor blocks. Accordingly, process flow moves to more blocks operation 424.

In more blocks operation 424, a determination is made as to whether there are more blocks within the trace. If a determination is made that there are no more blocks within the trace, then process flow exits at exit operation 426. However, if a determination is made that there are more blocks within the trace, then process flow returns to next block operation 410.

In this example, a determination is made in more blocks operation 424 that there are more blocks in trace 110, i.e., basic block 108. Accordingly, process flow moves to next block operation 410.

In next block operation 410, the next block in the trace following the present target block becomes the new target block. As set forth above, basic block 104 is the present target block. Accordingly, in next block operation 410, basic block 108 becomes the new target block.

From next block operation 410, in determine predecessor block operation 412, the predecessor block of the present target block is determined. In this example, basic block 108 is the present target block. The predecessor block is basic block 104. Accordingly, in determine predecessor block operation 412, a determination is made that basic block 104 is the predecessor block of the present target block, i.e., basic block 108.

From determine predecessor block operation 412, in off trace successor block operation 414, a determination is made that there are no off trace successor blocks of the predecessor block, i.e., of basic block 104. Accordingly, process flow moves to more blocks operation 424.

In this example, a determination is made in more blocks operation 424 that there are no more blocks in trace 110, i.e., that basic block 108 is the last block of trace 110. Accordingly, process flow exits at exit operation 426.

By updating the use set of the join instructions with the global_live_in of the off trace basic blocks of the predecessor block as discussed above, undesirable code motion is prevented. More particularly, code motion which redefines a live value is prevented. Specifically, instructions which redefine a live value in a register are not moved upwards past a join instruction which includes a global live in which includes the register. In this manner, instructions are scheduled recognizing data dependencies from off trace basic blocks.

FIG. 6 is trace block 300 of FIG. 3 after scheduling of instructions to maximize efficiency in accordance with one embodiment of the present invention. Referring now to FIGS. 2, 3 and 6 together, from build trace block operation 212, the instructions within trace block 300 are scheduled to maximize efficiency in schedule instructions within trace block operation 214.

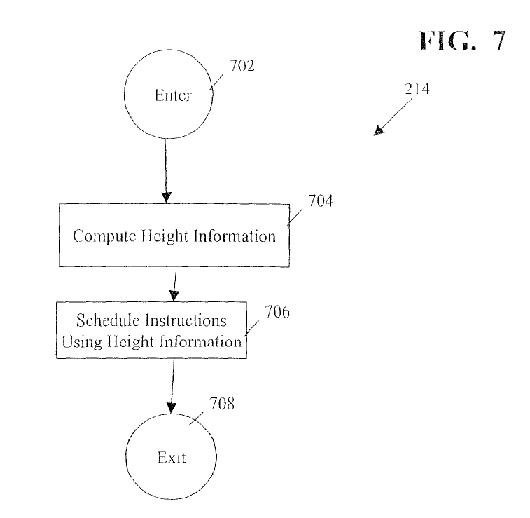

FIG. 7 is a flow chart of schedule instructions within trace block operation 214 of the flow chart of FIG. 2 in accordance with one embodiment of the present invention. Referring now to FIG. 7, from an enter operation 702, process flow moves to a compute height information operation 704. In compute height information operation 704, the height information of the instructions within trace block 300 of FIG. 3 are computed.

In one embodiment, the height information of an instruction is computed using adjusted execution times of instructions. The adjusted execution time of an instruction is the execution time of the instruction multiplied by an execution probability factor.

In one embodiment, the execution probability factor is the probability of execution of the basic block, which contains the instruction, relative to the head block of the trace. Stated another way, the execution probability factor is the execution frequency of the control flow through the basic block, which contains the instruction, relative to the execution frequency of the control flow through the head block of the trace.

For example, referring to FIGS. 1, 3 and 7 together, the probability of the control flow of control flow graph 100 of FIG. 1 through basic block 104 is less than 100 percent since sometimes control flow passes through off trace basic block 106. Instructions within basic block 104 are thus conditionally executed. For purposes of discussion, assume a case where the execution frequency of the control flow through basic block 104 is 80.

Basic block 102 is the head basic block of trace 110, i.e., is the first basic block of trace 110. Assume that the execution frequency of the control flow through basic block 102 is 100 and, thus, through basic block 108 is 100. Accordingly, in this example, the execution probability factor for instructions of basic block 104, e.g., instruction 170, is 80 divided by 100 or 0.8. The execution probability factor for instructions of basic block 102, e.g., instruction 112, is 100 divided by 100 or 1.0. Similarly, the execution probability factor for instructions of basic block 108, e.g., instructions 114, 116, 118, and 172, is 100 divided by 100 or 1.0.

Thus, the height information of instruction 170 is computed using the execution time of instruction 170 multiplied by the execution probability factor of 0.8. The height information of instructions 112, 114, 116, 118, and 172 is computed using the execution time of the instructions, since the execution probability factor is 1.0 for instructions 112, 114, 116, 118, and 172.

Although the height information of an instruction is described above as being computed using the adjusted execution time of the instruction, in light of this disclosure, those of skill in the art will understand that the height information is typically computed using not only the adjusted execution time, but other heuristics in addition. For example, the height information of an instruction is computed using the adjusted execution times of instructions which depend from the instruction, in addition to the adjusted execution time of the instruction.

From compute height information operation 704, in a schedule instructions using height information operation 706, the instructions within trace block 300 of FIG. 3 are scheduled using the height information computed in compute height information operation 704.

In one embodiment, the instructions within trace block 300 are scheduled using various parameters such as the register pressure, the execution frequency of the basic blocks, and the processor resources, in addition to the height information. Further, the instructions are scheduled recognizing data dependencies from off trace basic blocks as discussed above.

To illustrate, referring now to FIG. 6, in this embodiment, instructions 114, 116 have been moved to immediately follow instructions 112, 170, respectively. However, due to data dependencies from off trace basic block 106, instruction 116 is not moved to precede join instruction 304, i.e., is not moved to basic block 102.

To further illustrate, referring to FIG. 1, if instruction 116 was moved to basic block 102, then register r4 would contain the wrong value for instruction 122 of off trace basic block 106. More particularly, instruction 112 loads the value in memory location Mem0 into register r4, and this value is used in instruction 122.

However, if instruction 116 was moved into basic block 102 immediately following instruction 112, then the value assigned to register r4 during execution of instruction 116 would be used in error by instruction 122 of off trace basic block 106. However, since the use set of join instruction 304, which is associated with basic block 104, has been updated with the global_live_in, which includes the register r4, instruction 116 is prevented from moving above basic block 104. In this manner, errors in execution of instructions in off trace basic blocks are prevented.

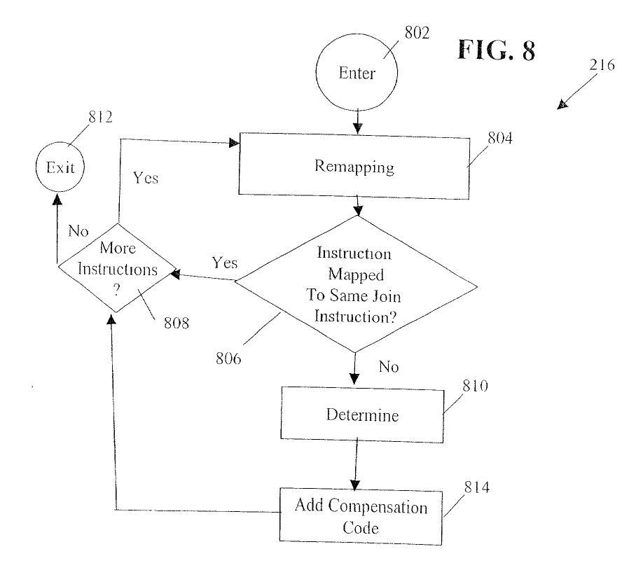

Referring again to FIG. 2, from schedule instructions within trace block operation 214, process flow moves to generate compensation code operation 216. FIG. 8 is a flow chart of generate compensation code operation 216 of flow chart 200 of FIG. 2 in accordance with one embodiment of the present invention.

Referring now to FIGS. 6 and 8 together, from enter operation 802, process flow moves to remapping operation 804. In remapping operation 804, each instruction of trace block 300 is mapped to the preceding join instruction. To illustrate, referring now to FIG. 6, instruction 112 is mapped to join instruction 302.

From remapping operation 804, in instruction mapped to same join instruction operation 806, a determination is made whether the instruction is mapped to the same join instruction as before the instructions were scheduled within the trace block. If the instruction is mapped to the same join instruction, then process flow moves to more instructions operation 808. However, if the instruction is not mapped to the same join instruction, then process flow moves to determine operation 810.

In this embodiment, instruction 112 was mapped to join instruction 302 before the instructions were scheduled within trace block 300 as illustrated in FIG. 3. Since instruction 112 is mapped to join instruction 302 after the instructions were scheduled within trace block 300 as illustrated in FIG. 6, instruction 112 is mapped to the same join instruction, i.e., join instruction 302, as before the instructions were scheduled within trace block 300. Thus, process flow moves from instruction mapped to same join instruction operation 806 to more instructions operation 808.

In more instructions operation 808, a determination is made as to whether or not there are more instructions in the trace block. If there are no more instructions in the trace block, then process flow exits in an exit operation 812. However, if there are more instructions in the trace block, then process flow returns to remapping operation 804.

In this embodiment, a determination is made in more instructions operation 808 that there are more instructions in trace block 300, e.g., that instruction 114 is within trace block 300. Accordingly, process flow moves to remapping operation 804.

In remapping operation 804, instruction 114 is mapped to join instruction 302. In instruction mapped to same join instruction operation 806, a determination is made that instruction 114 is not mapped to the same join instruction as before the instructions were scheduled within trace block 300.

More particularly, instruction 114 was mapped to join instruction 306 before the instructions were scheduled within trace block 300 as illustrated in FIG. 3. However, instruction 114 is mapped to join instruction 302 after the instructions were scheduled within trace block 300 as illustrated in FIG. 6 and discussed above.

Since instruction 114 is not mapped to the same join instruction as before the instructions were scheduled within trace block 300, process flow moves to determine operation 810. In determine operation 810, the destination and home blocks of the instruction are determined. The home block is the basic block in which the instruction was mapped before scheduling. Conversely, the destination block is the basic block in which the instruction is mapped after scheduling. Stated another way, the instruction moves from the home block to the destination block during scheduling of the instructions within the trace block.

In this embodiment, instruction 114 was mapped to join instruction 306 before the instructions were scheduled and mapped to join instruction 302 after the instructions were scheduled. As discussed above, join instruction 306 is associated with basic block 108 (FIG. 1) and join instruction 302 is associated with basic block 102 (FIG. 1). Accordingly, a determination is made that basic block 108 is the home block and that basic block 102 is the destination block in determine operation 810.

From determine operation 810, process flow moves to add compensation code operation 814. In add compensation code operation 814, compensation code is added to the off trace block (or off trace block flow) as discussed further below. From add compensation code operation 814, process flow moves to more instructions operation 808, which was discussed above.

Process flow then moves through operations 804, 806, 808 and/or operations 804, 806, 810, 814, 808 until a determination is made in more instructions operation 808 that there are no more instructions, and thus exits at exit operation 812.

In one embodiment, instead of mapping each instruction of trace block 300 to the preceding join instruction and then proceeding to instruction mapped to same join instruction operation 806, all of the instructions of trace block 300 are mapped to the preceding join instruction at one time in remapping operation 804. In accordance with this embodiment, if a determination is made in more instructions operation 808 that there are more instructions, then process flow moves directly back to instruction mapped to same join instruction operation 806 for the next instruction.

Referring again to FIG. 2, from generate compensation code operation 216, process flow moves to restore basic blocks in trace operation 218. In restore basic blocks in trace operation 218, the instructions are moved, sometimes called restored, from the trace block back into the basic blocks.

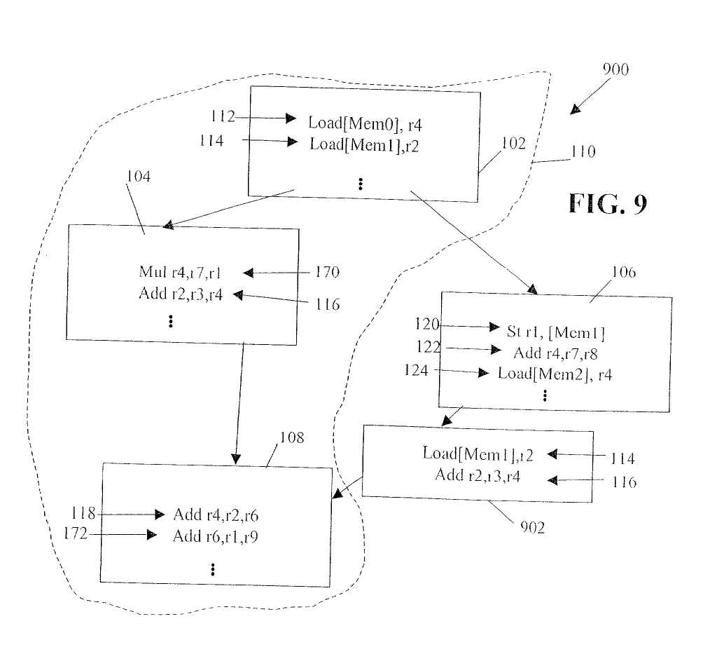

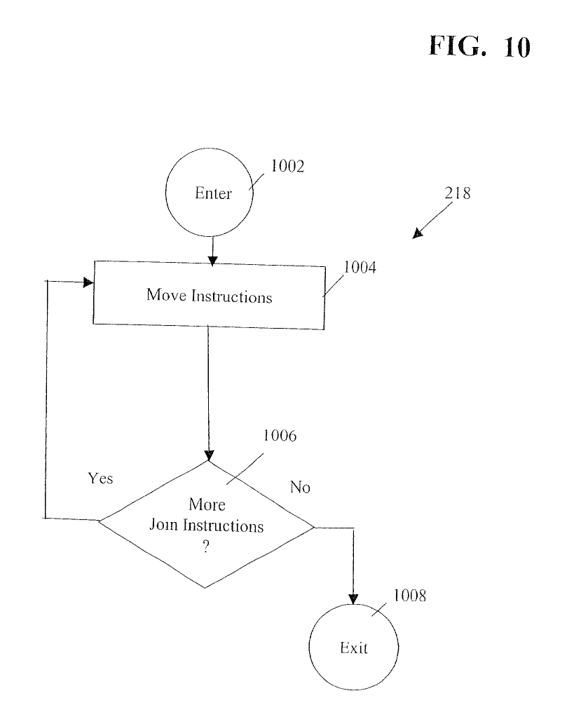

FIG. 9 is a control flow graph 900 after scheduling of instructions in accordance with one embodiment of the present invention. FIG. 10 is a flow chart of restore basic blocks in trace operation 218 of flow chart 200 of FIG. 2 in accordance with one embodiment of the present invention.

Referring now to FIGS. 6, 9 and 10 together, from an enter operation 1002, process flow moves to a move instructions operation 1004. For the first join instruction, all of the instructions following the first join instruction (and preceding the following join instruction if one exists) are moved to the basic block associated with the first join instruction.

In this embodiment, the first join instruction is join instruction 302. The following join instruction is join instruction 304. Instructions 112 and 114 follow join instruction 302 and precede join instruction 304. As discussed above, join instruction 302 is associated with basic block 102. Thus, instructions 112 and 114 are moved into basic block 102 as shown in FIG. 9.

From move instructions operation 1004, in a more join instructions operation 1006, a determination is made as to whether or not there are more join instructions in the trace block. If there are more join instructions, process flow returns to move instructions operation 1004 and the following join instruction becomes the present join instruction. However, if there are no more join instructions, i.e., the present join instruction is the last join instruction, process flow moves to exit operation 1008.

In this embodiment, a determination is made in more join instructions operation 1006 that there are more join instructions in trace block 300, e.g., that join instruction 304 is within trace block 300. Accordingly, join instruction 304 becomes the present join instruction and process flow returns to move instructions operation 1004.

The present join instruction is now join instruction 304. The following join instruction is now join instruction 306. As discussed above, join instruction 304 is associated with basic block 104. Instructions 170 and 116 follow join instruction 304 and precede join instruction 306. Thus, instructions 170 and 116 are moved into basic block 104 as shown in FIG. 9.

From move instructions operation 1004, in more join instructions operation 1006, a determination is made that there are more join instructions in trace block 300, e.g., that join instruction 306 is within trace block 300. Accordingly, process flow returns to move instructions operation 1004.

The present join instruction is now join instruction 306, which is the last join instruction. As discussed above, join instruction 306 is associated with basic block 108. Instructions 118 and 172 follow join instruction 306 and are moved to basic block 108 as shown in FIG. 9.

From move instructions operation 1004, in more join instructions operation 1006, a determination is made that there are no more join instructions in trace block 300. Accordingly, process flow exits at exit operation 1008.

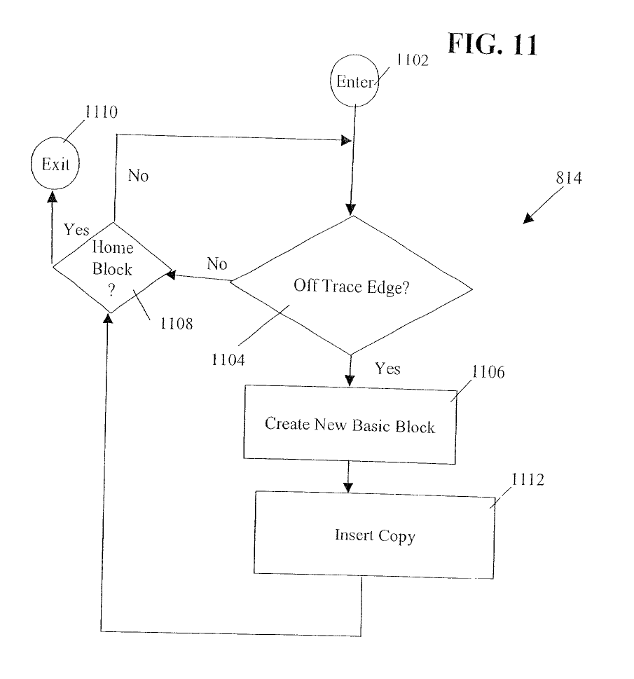

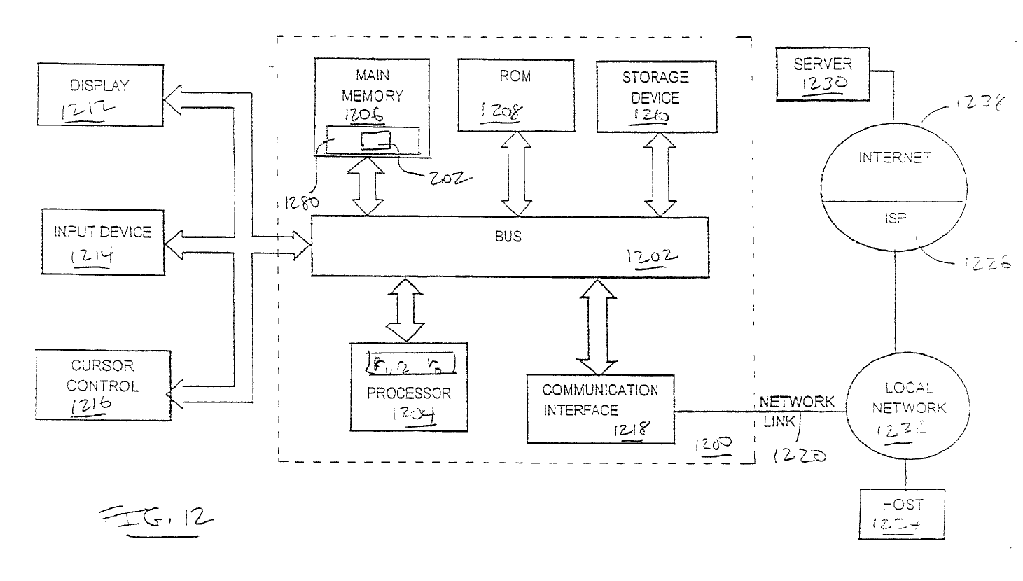

FIG. 11 is a flow chart of add compensation code operation 814 of the flow chart of FIG. 8 in accordance with one embodiment of the present invention. Referring now to FIGS. 6, 9 and 11 together, in this illustration, instruction 114 is the present instruction being operated upon. As discussed above, the destination block of instruction 114 is basic block 102 and the home block of instruction 114 is basic block 108. The region of trace 110 between the destination block and the home block of the instruction is analyzed as discussed below to determine if compensation code is necessary.

Beginning with the successor block to the destination block, i.e., basic block 104 which is the first target basic block, from an enter operation 1102 (FIG. 11), process flow moves to an off trace edge operation 1104.

In off trace edge operation 1104, a determination is made for the target basic block whether there is an incoming edge from an off trace basic block. If there is an incoming edge from an off trace basic block, process flow moves to create new basic block operation 1106. However, if there is not an incoming edge from an off trace basic block, process flow moves to home block operation 1108.

In this embodiment, there is no incoming edge from an off trace basic block coming into basic block 104. Accordingly, in off trace edge operation 1104, a determination is made that there is not an incoming edge from an off trace basic block and process flow moves to home block operation 1108.

Basic block 104 is not the home block of instruction 114. Thus, a determination is made that the target basic block is not the home block of the instruction in home block operation 1108. Accordingly, process flow returns to off trace edge operation 1104.

The next basic block becomes the target basic block. In this embodiment, basic block 108 becomes the target basic block. As shown in FIG. 9, there is an incoming edge from off trace basic block 106 coming into basic block 108. Accordingly, in off trace edge operation 1104, a determination is made that there is an incoming edge from an off trace basic block. Thus, process flow moves to create new basic block operation 1106.

In create new basic block operation 1106, a new basic block is created between the off trace basic block and the target basic block, unless a basic block has already been created previously in create new basic block operation 1106. In this embodiment, a new basic block 902 is created between off trace basic block 106 and basic block 108, i.e., the target block. Basic block 902 is hereinafter referred to as a compensation basic block.

From create new basic block operation 1106, process flow moves to insert copy operation 1112. A copy of the moved instruction is inserted into the compensation basic block in insert copy operation 1112.

In this embodiment, the moved instruction is instruction 114. Thus, a copy of instruction 114 is inserted into compensation basic block 902 as shown in FIG. 9. From insert copy operation 1112, process flow moves to home block operation 1108. Operations 1104, 1106, 1112, and 1108 are repeated until a determination is made in home block operation 1108 that the target basic block is the home block, and the process flow exits at exit operation 1110. As should be readily apparent, instruction 116 is inserted into compensation basic block 902 for reasons similar to those discussed above with regards to instruction 114.

Referring now to FIG. 9, by adding compensation basic block 902 containing instructions 114, 116, the correct values are placed in registers r2, r4, even if process flow moves in the off trace path through off trace basic block 106.

FIG. 12 is a block diagram illustrating a computer system 1200 upon which an embodiment in accordance with the present invention may be implemented. Computer system 1200 includes a bus 1202 or other communication mechanism for communicating information, and a processor 1204 coupled with bus 1202 for processing information. Processor 1204 contains registers r1, r2, . . . rn as indicated.

Computer system 1200 also includes a main memory 1206, such as a random access memory (RAM) or other dynamic storage device, coupled to bus 1202 for storing information and instructions to be executed by processor 1204. In one embodiment, main memory 1206 has stored therein a compiler 1280 including a trace scheduler 202 in accordance with the present invention. Main memory 1206 also may be used for storing temporary variables or other intermediate information during execution of instructions by processor 1204.

Computer system 1200 also includes a read only memory (ROM) 1208 or other static storage device coupled to bus 1202 for storing static information and instructions for processor 1204. A storage device 1210, such as a magnetic disk or optical disk, is also provide and coupled to bus 1202 for storing information and instructions.

Computer system 1200 may also be coupled via bus 1202 to a display 1212, such as a cathode ray tube (CRT), for displaying information to a computer user. An input device 1214, including alphanumeric and other keys, is also provided and coupled to bus 1202 for communicating information and command selections to processor 1204.

Another type of user input device is cursor control 1216, such as a mouse, a trackball, or cursor direction keys for communicating direction information and command selections to processor 1204 and for controlling cursor movement on display 1212. This input device typically has two degrees of freedom in two axes, a first axis (e.g., x or horizontal) and a second axis (e.g., y or vertical), which allows the device to specify positions in a plane.

Computer system 1200 is used to schedule instructions after register allocation using a trace scheduler in accordance with various embodiments of the present invention. According to one embodiment, the scheduling of instructions using a trace scheduler is provided by computer system 1200 in response to processor 1204 executing sequences of instructions contained in main memory 1206.

Such instructions may be read into main memory 1206 from another computer-readable medium, such as storage device 1210. However, the computer-readable medium, sometimes called a computer program product, is not limited to devices such as storage device 1210. For example, the computer-readable medium may include a floppy disk, a flexible disk, hard disk, magnetic tape, or any other magnetic medium, a CD-ROM, any other optical medium, a RAM, a PROM, and EPROM, a FLASH-EPROM, any other memory chip or cartridge, or any other medium from which a computer is capable of reading. Execution of the sequences of instructions contained in main memory 1206 causes processor 1204 to perform the operations previously described. In alternative embodiments, hard-wired circuitry may be used in place of or in combination with software instructions. Thus, embodiments in accordance with the present invention are not limited to any specific combination of hardware circuitry and software.

Computer system 1200 also includes a communication interface 1218 coupled to bus 1202. Communication interface 1218 provides a two-way data communication coupling to a network link 1220 to a local network 1222.

For example, if communication interface 1218 is an integrated services digital network (ISDN) card or a modem, communication interface 1218 provides a data communication connection to the corresponding type of telephone line.

If communication interface 1218 is a local area network (LAN) card, communication interface 1218 provides a data communication connection to a compatible LAN. Wireless links are also possible. In any such implementation, communication interface 1218 sends and receives electrical, electromagnetic or optical signals which carry digital data streams representing various types of information.

Network link 1220 typically provides data communication through one or more networks to other data devices. For example, network link 1220 may provide a connection through local network 1222 to a host computer 1224 or to data equipment operated by an Internet Service Provider (ISP) 1226.

ISP 1226 in turn provides data communication services through the world wide packet data communication network now commonly referred to as the “Internet” 1228. Local network 1222 and Internet 1228 both use electrical, electromagnetic or optical signals which carry digital data streams. The signals through the various networks and the signals on network link 1220 and through communication interface 1218, which carry the digital data to and from Computer system 1200 are exemplary forms of carrier waves transporting the information.

Computer system 1200 is capable of sending messages and receiving data, including program code, through the network(s), network link 1220 and communication interface 1218. In the Internet example, a server 1230 might transmit a requested code for an application program through Internet 1228, ISP 1226, local network 1222 and communication interface 1218. In accordance with one embodiment of the present invention, one such downloaded application provides for the scheduling of instructions after register allocation using a trace scheduler as described herein.

The received code may be executed by processor 1204 as it is received, and/or stored in storage device 1210, or other non-volatile storage for later execution. In this manner, Computer system 1200 may obtain application code in the form of a carrier wave.

The embodiments described herein may be employed as part of a computer language compiler or as a stand alone process for scheduling of instructions after register allocation using a trace scheduler.

While the invention has been shown with reference to particular embodiments thereof, it will be understood by those skilled in the art that various other changes in the form and details may be made therein without departing from the spirit and scope of the invention.

What is claimed is:

1. A method comprising:
allocating registers;
building a trace comprising basic blocks; and
scheduling instructions within said trace after said allocating registers.

2. The method of claim 1 wherein said scheduling instructions comprises moving instructions between said basic blocks.

3. The method of claim 1 further comprising building a control flow graph comprising said basic blocks.

4. The method of claim 3 wherein said control flow graph comprises an off trace basic block.

5. The method of claim 4 wherein said scheduling instructions comprises recognizing data dependencies from said off trace basic block.

6. The method of claim 1 wherein said scheduling instructions comprises computing height information of said instructions.

7. The method of claim 6 wherein said height information is computed using execution probabilities of said basic blocks.

8. The method of claim 6 wherein said height information is computed using adjusted execution times of said instructions.

9. The method of claim 1 wherein said scheduling instructions comprises computing an adjusted execution time of an instruction of said instructions by multiplying an execution time of said instruction by an execution probability factor.

10. The method of claim 1 wherein said scheduling instructions comprises generating compensation code.

11. The method of claim 1 wherein said scheduling instructions comprises:
building a trace block comprising said instructions;
scheduling said instructions within said trace block; and
moving said instructions from said trace block to said basic blocks.

12. A method comprising:
allocating registers;
building a trace after said allocating registers, said trace comprising basic blocks comprising instructions;
building a trace block comprising said instructions;
scheduling said instructions within said trace block; and
moving said instructions from said trace block to said basic blocks.

13. The method of claim 12 wherein said building a trace block comprises inserting a join instruction into said trace block, said join instruction being a delimiter for a first basic block of said basic blocks.

14. The method of claim 13 further comprising updating a use set of said join instruction with a global_live_in for an off trace basic block.

15. The method of claim 14 wherein said global_live_in is a set of registers which contain live values when entering said off trace basic block.

16. The method of claim 15 wherein an instruction of said instructions which defines a value in said set of registers is not moved past said join instruction during said scheduling said instructions.

17. The method of claim 12 wherein said scheduling said instructions comprises computing height information of said instructions.

18. The method of claim 17 wherein said height information is computed using execution probabilities of said basic blocks.

19. A system comprising:
a processor; and
a memory having a method of scheduling instructions therein, wherein upon execution of said method, said method comprises:
allocating registers;
building a trace comprising basic blocks; and
scheduling instructions within said trace after said allocating registers.

20. The system of claim 19 wherein said scheduling instructions comprises moving instructions between said basic blocks.

21. The system of claim 19 wherein said method further comprising building a control flow graph comprising said basic blocks.

22. The system of claim 21 wherein said control flow graph comprises an off trace basic block.

23. The system of claim 22 wherein said scheduling instructions comprises recognizing data dependencies from said off trace basic block.

24. The system of claim 19 wherein said scheduling instructions comprises computing height information of said instructions.

25. The system of claim 24 wherein said height information is computed using execution probabilities of said basic blocks.

26. The system of claim 24 wherein said height information is computed using adjusted execution times of said instructions.

27. The system of claim 19 wherein said scheduling instructions comprises generating compensation code.

28. A computer system comprising:
means for allocating registers;
means for building a trace comprising basic blocks; and
means for scheduling instructions within said trace after said registers are allocated by said means for allocating.

29. A computer program product having a method of scheduling instructions stored therein, wherein upon execution of said method, said method comprises:
allocating registers;
building a trace comprising basic blocks; and
scheduling instructions within said trace after said allocating registers.
